(19) United States
(12) Patent Application Publication
(10) Pub. No.: US 2026/0100495 A1
(43) Pub. Date: Apr. 9, 2026

(54) CASCADE DE-EMBEDDING METHODS FOR RF, MMWAVE, AND PHOTONICS TRANSMISSION LINES

(71) Applicant: Lorentz Solution, Inc., Santa Clara, CA (US)

(72) Inventors: Jinsong Zhao, Palo Alto, CA (US); Siamak Abdollahi, Richmond Hill (CA)

(21) Appl. No.: 18/981,373

(22) Filed: Dec. 13, 2024

Related U.S. Application Data
(60) Provisional application No. 63/703,908, filed on Oct. 4, 2024.

(51) Int. Cl. H01P 11/00

(52) U.S. Cl. CPC H01P 11/001

(57) ABSTRACT

A method of de-embedding includes providing a first transmission line with a first length and a second transmission line with a second length greater than the first length. Each of the first and second transmission lines is terminated by a respective pad at each end thereof. The method further includes obtaining a first matrix representing measured data of the first transmission line, and a second matrix representing measured data of the second transmission line, and constructing a third transmission line having a third length relating to a difference between the second length and the first length and a scaling factor. The method further includes determining a third matrix based on the first matrix, the second matrix, and the scaling factor, and determining a fourth matrix representing intrinsic properties of the first transmission line without parasitic effects of the pads based on the first matrix and the third matrix.

### CROSS-REFERENCE TO RELATED APPLICATIONS

The present application is a non-provisional application of and claims the benefit and priority under 35 U.S.C. 119 (e) of U.S. Provisional Application No. 63/703,908, filed Oct. 4, 2024 entitled “ACCURATE CASCADE DE-EMBEDDING METHOD FOR RF, MMWAVE AND PHOTONICS TRANSMISSION LINES,” the entire content of which is incorporated herein by reference for all purposes.

### FIELD

Embodiments of the present disclosure relate to de-embedding for transmission lines in high-frequency electronics, in particular millimeter-wave (mmWave) and sub-terahertz transmission lines (TLs), by removing parasitic effects of external test fixtures, such as test pads and tapered lines.

### BACKGROUND

De-embedding is an important technique in high-frequency measurements, in particular for mmWave devices, where it is necessary to isolate the intrinsic characteristics of a device under test (DUT) by removing parasitic effects introduced by the measurement setup (e.g., test pads for connecting to external testing equipment). Traditional de-embedding methods use two transmission lines with a fixed length ratio, typically a ratio of 1:2. As feature sizes shrink in advanced electronics and as the frequency of operation escalates beyond 75 GHZ, conventional de-embedding techniques can face significant limitations. For example, requiring a fixed length ratio can introduce constraints in design flexibility and can lead to inaccuracies when dealing with high-frequency parasitic interactions between transmission lines and external fixtures such as radio-frequency (RF) pads. For example, precision fabrication can be difficult due to manufacturing imperfections. Long transmission lines can also be wasteful and even impractical in real applications. Therefore, there is a need for improved de-embedding techniques.

### SUMMARY

Embodiments of the present disclosure provide a method of de-embedding transmission lines. The method includes providing a first transmission line formed on a wafer. The first transmission line has a first length L₁ and is terminated by a respective pad at each end thereof. The method further includes providing a second transmission line formed on the wafer. The second transmission line has a second length L₂ and is terminated by a respective pad at each end thereof. The second length L₂ is greater than the first length L₁. The method further includes obtaining a first matrix [T_{L1_t}] representing measured data of the first transmission line including parasitic effects of the pads, and a second matrix [T_{L2_t}] representing measured data of the second transmission line including parasitic effects of the pads, and constructing a third transmission line having a third length L₃. The third length L₃ relates to a difference between the second length L₂ and the first length L₁ and a scaling factor s, where s is an integer greater than zero. The method further includes determining a third matrix [T_{L3_t}] based on the first matrix [T_{L1_t}], the second matrix [T_{L2_t}], and the scaling factor s. The method further includes determining a fourth matrix [T_{L1}] based on the first matrix [T_{L1_t}] and the third matrix [T_{L3_t}]. The fourth matrix [T_{L1}] represents intrinsic properties of the first transmission line without the parasitic effects of the pads.

### BRIEF DESCRIPTION OF THE DRAWINGS

FIG. 1 illustrates a test structure that includes a first transmission line and a second transmission line formed on a wafer according to some embodiments.

FIG. 2 shows a flowchart illustrating a method of de-embedding according to some embodiments.

FIG. 3 illustrates a test structure that includes a first transmission line and a second transmission line with tapered portions, according to some embodiments.

FIG. 4 illustrates a test structure that includes a first transmission line and a second transmission line with tapered portions, according to some embodiments.

FIG. 5 shows results of the de-embedding method according to FIG. 2, for some exemplary test structures with length ratios n:(n+1), as compared to EM simulation results.

FIG. 6 shows results of the de-embedding method according to FIG. 2, for an exemplary test structure with an arbitrary length ratio, as compared to EM simulation results.

FIG. 7 illustrates a test structure that includes multi-port transmission lines according to some embodiments.

FIG. 8 illustrates a test structure that includes multi-port transmission lines with tapered portions, according to some embodiments.

FIG. 9 shows results of the de-embedding method according to FIG. 2, for the test structure illustrated in FIG. 7 including multi-port transmission lines, as compared to EM simulation results.

FIG. 10 shows a flowchart illustrating a method of de-embedding using an empirical de-embedding coefficient, according to some embodiments.

FIG. 11 shows results of the de-embedding method according to FIG. 10 for a test structure, as compared to the results of the de-embedding method according to FIG. 2 for the same test structure and to the EM simulation results.

### DETAILED DESCRIPTION

The following detailed description is exemplary in nature and is not intended to limit the disclosure or the application and uses of the disclosure. Furthermore, there is no intention to be bound by any expressed or implied theory presented in the preceding technical field, background, summary, brief description of the drawings, or the following detailed description.

In high-frequency applications, such as mmWave and photonic applications, transmission lines (TLs) are commonly used for signal transmission. De-embedding is a process of removing parasitic effects of test features, such as RF pads, from measured data to recover the intrinsic characteristics of a device under test (DUT). Traditional methods for de-embedding transmission lines use two transmission lines with a length ratio of 1:2. This approach limits its applicability, especially at higher frequencies.

Embodiments of the present disclosure provide more versatile methods of de-embedding for RF, mmWave, and photonics transmission lines with arbitrary length ratios, which can obviate the limitations imposed by conventional de-embedding methods. The methods can provide greater flexibility and improved accuracy in de-embedding. According to some embodiments, the de-embedding methods use matrix manipulations based on cascade properties of transmission lines, to allow their applicability to any length ratio, such as ratios of n:(n+1), where n is an integer greater than or equal to one, as well as completely arbitrary ratios.

The de-embedding methods according to embodiments of the present disclosure can also be applied to transmission lines with non-uniform geometries, such as transmission lines with tapered ends, which are often used in mmWave and sub-mm Wave applications. Tapered transmission lines can introduce additional parasitic effects due to the gradual change in geometry. Conventional de-embedding methods may not be effective in accounting for such variations. By modeling the parasitic effects of pads and transitions using T-matrices the methods can ensure that the de-embedding process accurately reflects the behavior of non-uniform transmission lines. This broad applicability allows for accurate extraction of intrinsic characteristics of transmission lines even in designs where transmission line widths vary, ensuring reliable high-frequency measurements across a wide range of configurations.

The accuracies of the de-embedding methods can be verified and quantified against three-dimensional (3D) electromagnetic (EM) simulation results. By comparing the de-embedded transmission line characteristics with results from the EM simulations, the methods provide an additional layer of validation, ensuring that any residual errors caused by parasitic effects are identified and corrected. This is important, in particular, for high-frequency transmission lines operating at frequencies up to 200 GHz or beyond.

According to some embodiments, to improve the de-embedding accuracy, an empirical de-embedding coefficient is used in the de-embedding process. The de-embedding coefficient is derived from 3D EM simulations.

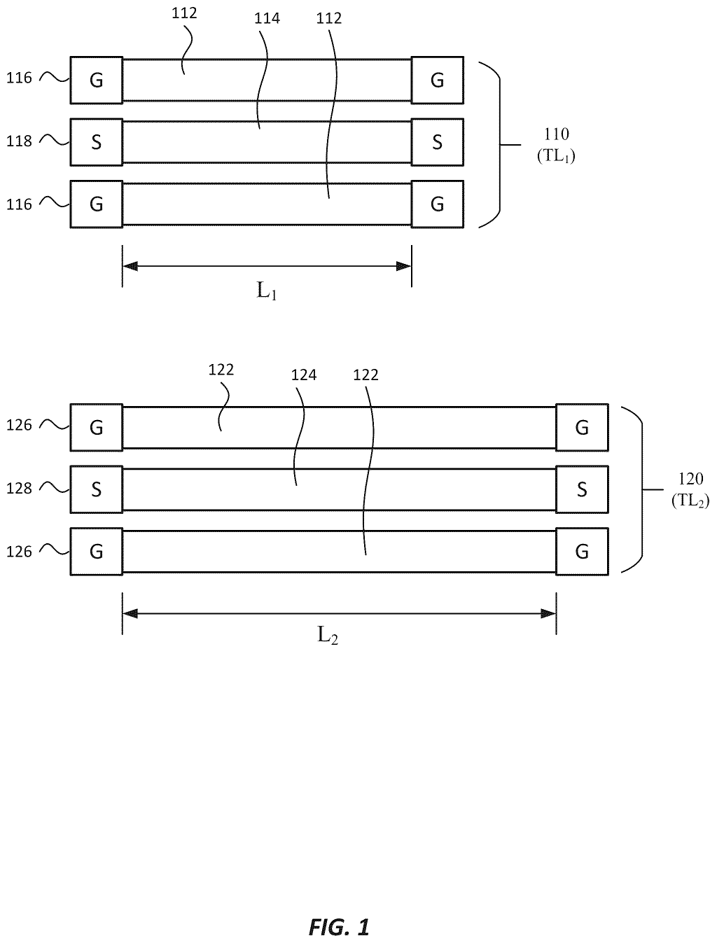

Turning to the drawings, FIG. 1 illustrates a test structure that includes a first transmission line 110 (TL₁) and a second transmission line 120 (TL₂) formed on a wafer, according to some embodiments. The first transmission line 110 includes a signal line 114 terminated by a respective signal pad 118 at each end thereof. The first transmission line 110 includes two metal traces 112 for the ground. Each metal trace 112 is terminated by a respective ground pad 116 at each end thereof. The second transmission line 120 includes a signal line 124 terminated by a respective signal pad 128 at each end thereof. The second transmission line 120 includes two metal traces 122 for the ground. Each metal trace 122 is terminated by a respective ground pad 126 at each end thereof. This transmission line configuration is referred to as ground-signal-ground (GSG) configuration. The de-embedding methods according to embodiments of the present invention are applicable to transmission lines with other configurations as well, such as transmission lines with GSSG, GSGSG, SS, or GSSSG configurations.

According to some embodiments, the first transmission line 110 and the second transmission line 120 are coplanar waveguides. In this embodiment, the signal lines 114 and 124, as well as the metal traces 112 and 122, are all straight, and have the same width. It is assumed that the signal pads 118 and the ground pads 116 of the first transmission line 110, and the signal pads 128 and the ground pads 126 of the second transmission line 120 have substantially the same geometry. The first transmission line 110 has a first length L₁. The second transmission line 120 has a second length L₂. The second length L₂ is greater than the first length L₁. Here, the length of a transmission line refers to the length of the signal line 214 or 224, or the length of the metal trace 212 or 222. According to embodiments of the present disclosure, the ratio of the first length L₁ to the second length L₂ can be arbitrary.

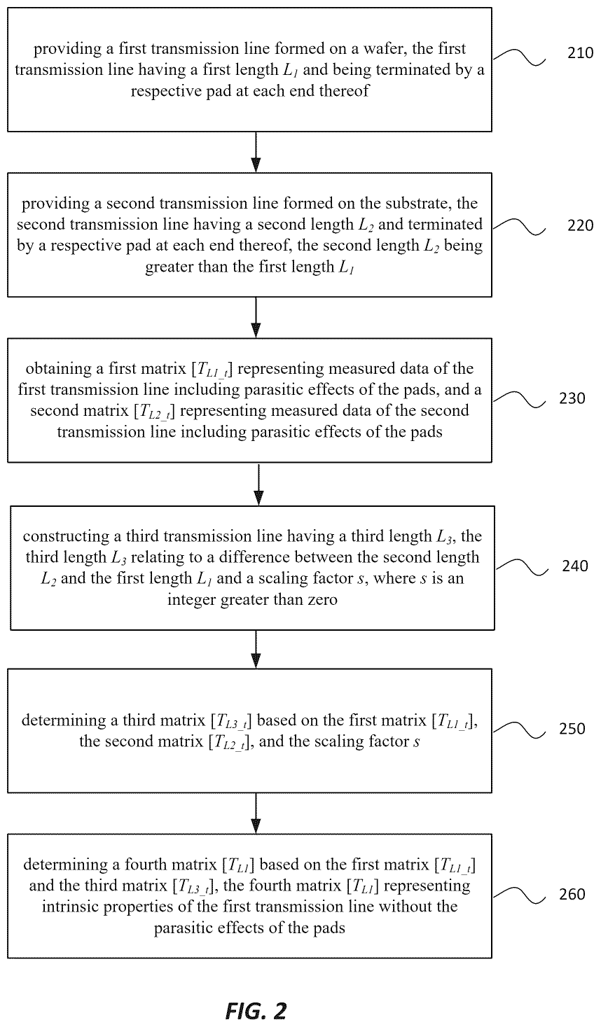

FIG. 2 shows a flowchart illustrating a method of de-embedding according to some embodiments. The method includes, at 210, providing a first transmission line TL₁ formed on a wafer. The first transmission line TL₁ has a first length L₁ and is terminated by a respective pad at each end thereof. The method further includes, at 220, providing a second transmission line TL₂ formed on the same wafer. The second transmission line TL₂ has a second length L₂ and is terminated by a respective pad at each end thereof. The second length L₂ is greater than the first length L₁.

The method further includes, at 230, obtaining a first matrix [TL_{L1_t}] representing measured data of the first transmission line TL₁, and a second matrix [T_{L2_t}] representing measured data of the second transmission line TL₂. Here, the subscript “_t” denotes that the measured data includes parasitic effects of the pads. In some embodiments, each of the first matrix [T_{L1_t}] and the second matrix [T_{L2_t}] is a T-matrix. If raw measured data are represented by S-matrix, the method can further include converting the S-matrix into T-matrix. The first matrix [T_{L1_t}] and the second matrix [T_{L2_t}] can be expressed as follows:

$$[ {T}_{L {1}_{t}} ] = [ {T}_{PAD} ] \times [ {T}_{L 1} ] \times , and \qquad Eqn . ( 1 )$$

$$[ {T}_{L {2}_{t}} ] = [ {T}_{PAD} ] \times [ {T}_{L 2} ] \times [ {T}_{PAD} ] , \qquad Eqn . ( 2 )$$

where [T_{PAD}] is a pad T-matrix representing the parasitic effects of the pad, [T_{L1}] and [T_{L2}] are matrices representing intrinsic T-matrices of the first transmission line TL₁ and the second transmission line TL₂, respectively. The goal of the de-embedding is to recover the intrinsic T-matrices [T_{L1}] and [T_{L2}] from the measured T-matrices [T_{L1_t}] and [T_{L2_t}], i.e., removing the parasitic effects of the pads from the measured T-matrices [T_{L1_t}] and [T_{L2_t}].

The method further includes, at 240, constructing a third transmission line TL₃. The third transmission line TL₃ is constructed for matrix manipulations to recover the intrinsic T-matrices [T_{L1}] and [T_{L2}]. The third transmission line TL₃ has a third length L₃ relating to a difference between the first length L₁ and the second length L₂ and a scaling factor s. According to some embodiments, the third length L₃ is expressed as follows:

$${L}_{3} = s ( {L}_{1} - {L}_{2} ) + {L}_{1} , \qquad Eqn . ( 3 )$$

where the scaling factor s is expressed as:

$$s = floor ( \frac{{L}_{1}}{{L}_{2} - {L}_{1}} ) , \qquad Eqn . ( 4 )$$

where the function floor (x) returns the greatest integer less than or equal to the argument x.

The method further includes, at 250, determining a third matrix [T_{L3_t}] representing “measured data” of the third transmission line TL₃. Here, [T_{L3_t}] is not actually “measured”; it is referred to as “measured data” to indicate that it includes the parasitic effects of the pads. According to Equation (3), the third matrix [T_{L3_t}] can be obtained as the following:

$$[ {T}_{L {3}_{t}} ] = {[ [ {T}_{L {1}_{t}} ] \times {[ {T}_{L {2}_{t}} ]}^{- 1} ]}^{s} \times [ {T}_{L {1}_{t}} ] . \qquad Eqn . ( 5 )$$

The method further includes, at 260, determining a fourth matrix [T_{L1}] based on the first matrix [T_{L1_t}] and the third matrix [T_{L3_t}]. The fourth matrix [T_{L1}] represents intrinsic properties of the first transmission line T_{L1} without the parasitic effects of the pads. The method can further include determining a fifth matrix [T_{L2}] based on the second matrix [T_{L2_t}] and the third matrix [T_{L3_t}]. The fifth matrix [T_{L2}] represents intrinsic properties of the second transmission line TL₂ without the parasitic effects of the pads. The algorithms for obtaining the fourth matrix [T_{L1}] and the fifth matrix [T_{L2}] are described below, both in special cases in which the ratio of L₁ and L₂ is n:(n+1), and in general cases for arbitrary ratios of L₁ and L₂.

For special cases in which L₁=nL, and L₂=(n+1) L, where n is an integer greater than 1 (or equal to 1), s=n, and L₃=0. In such special cases, the ratio of L₁ and L₂ is n:(n+1). (L may be referred herein as a base length.) Once [T_{L3_t}] is obtained according to Equation (5), the pad transfer matrix [T_{PAD}] can be obtained by solving the following equation:

$$[ {T}_{L {3}_{t}} ] = [ {T}_{P A D} ] \times [ {T}_{L 3} ] \times [ {T}_{P A D} ] = [ {T}_{P A D} ] \times [ {T}_{P A D} ] , \qquad ( 6 )$$

since [T_{L3}] is unity for L₃=0. Then, the intrinsic T-matrices [T_{L1}] and [T_{L2}] can be obtained as the following:

$$[ {T}_{L 1} ] = {[ {T}_{L {3}_{t}} ]}^{\frac{- 1}{2}} \times [ {T}_{L {1}_{t}} ] \times {[ {T}_{L {3}_{t}} ]}^{\frac{- 1}{2}} , and \qquad Eqn . ( 7 )$$

$$[ {T}_{L 2} ] = {[ {T}_{L {3}_{t}} ]}^{\frac{- 1}{2}} \times [ {T}_{L {2}_{t}} ] \times {[ {T}_{L {3}_{t}} ]}^{\frac{- 1}{2}} . \qquad Eqn . ( 8 )$$

For general cases with arbitrary ratios of L₁ and L₂ (where L₃ is not zero but is small), the following equation holds:

$$[ {T}_{L {3}_{t}} ] = [ {T}_{P A D} ] \times [ {T}_{L 3} ] \times [ {T}_{P A D} ] = {[ [ {T}_{P A D} ] \times {[ {T}_{L 3} ]}^{\frac{1}{2}} ]}^{2} . \qquad Eqn . ( 9 )$$

Then, the intrinsic T-matrices [T_{L1}] and [T_{L2}] can be obtained as the following:

$$[ {T}_{L 1} ] = {[ {[ {T}_{L {3}_{t}} ]}^{\frac{- 1}{2}} * [ {T}_{L {1}_{t}} ] * {[ {T}_{L {3}_{t}} ]}^{\frac{- 1}{2}} ]}^{\frac{L 1}{{L}_{1} - {L}_{3}}} , and \qquad Eqn . ( 10 )$$

$$[ {T}_{L 2} ] = {[ {[ {T}_{L {3}_{t}} ]}^{\frac{- 1}{2}} * {[ {T}_{L {2}_{t}} ] [ {T}_{L {3}_{t}} ]}^{\frac{- 1}{2}} ]}^{\frac{{L}_{2}}{{L}_{2} - {L}_{3}}} . \qquad Eqn . ( 11 )$$

Thus, according to embodiments of the present disclosure, by constructing the third virtual transmission line TL₃, the intrinsic T-matrices [T_{L1}] and [T_{L2}] of the transmission lines TL₁ and TL₂ can be recovered from the measured T-matrices [T_{L1_t}] and [T_{L1_t}] for arbitrary ratios of L₁ and L₂, based on cascading properties of the T-matrix.

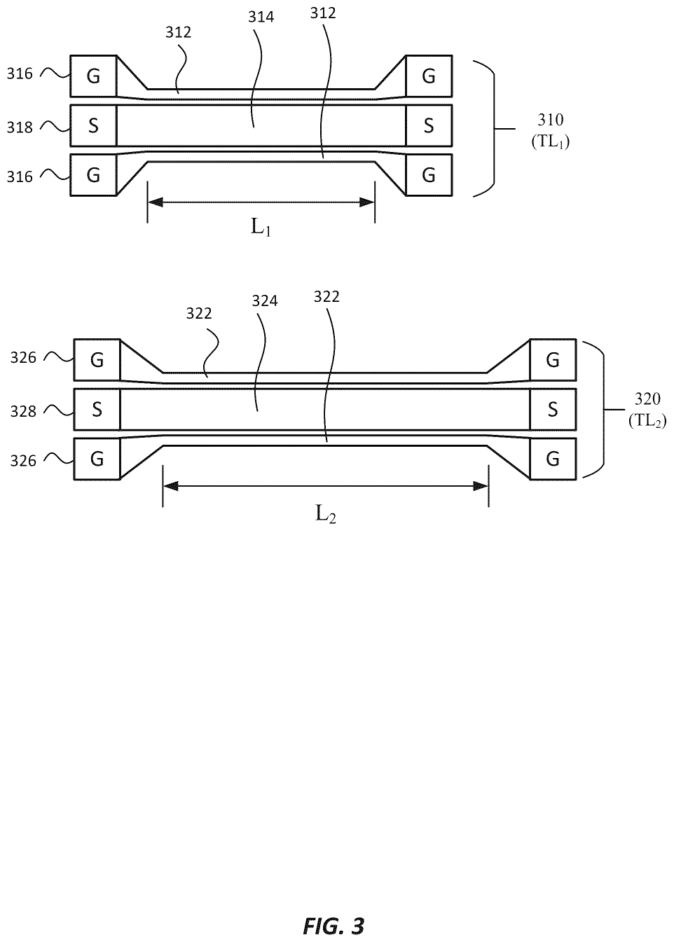

The method of de-embedding described above can also be applied to transmission lines that have tapered portions. FIG. 3 illustrates another test structure that includes a first transmission line 310 (TL₁) and a second transmission line 320 (TL₂) formed on a wafer. Similar to the test structure illustrated in FIG. 1, the first transmission line 310 includes a signal line 314 terminated by a respective signal pad 318 at each end thereof. The first transmission line 310 includes two metal traces 312 for the ground. Each metal trace 312 is terminated by a respective ground pad 316 at each end thereof. The second transmission line 320 includes a signal line 324 terminated by a respective signal pad 328 at each end thereof. The second transmission line 320 includes two metal traces 322 for the ground. Each metal trace 322 is terminated by a respective ground pad 326 at each end thereof. In this embodiment, the signal lines 314 and 324 are straight, but the metal traces 312 and 322 have tapered portions at the ends. The first transmission line 310 has a first length L₁. The second transmission line 320 has a second length L₂. Here, the length of a transmission line refers to the length of the portion of the metal trace 312 or 322 that is not tapered. The tapered portions of the transmission lines, as well as the pads 316 or 326, contribute to the parasitic effects. According to embodiments of the present disclosure, the ratio of the first length L₁ to the second length L₂ can be arbitrary. Other than the length difference, the first transmission line 310 and the second transmission line 320 have the same geometry (e.g., the signal lines 314 and 324 of the first transmission line 310 and the second transmission line 320 have the same width).

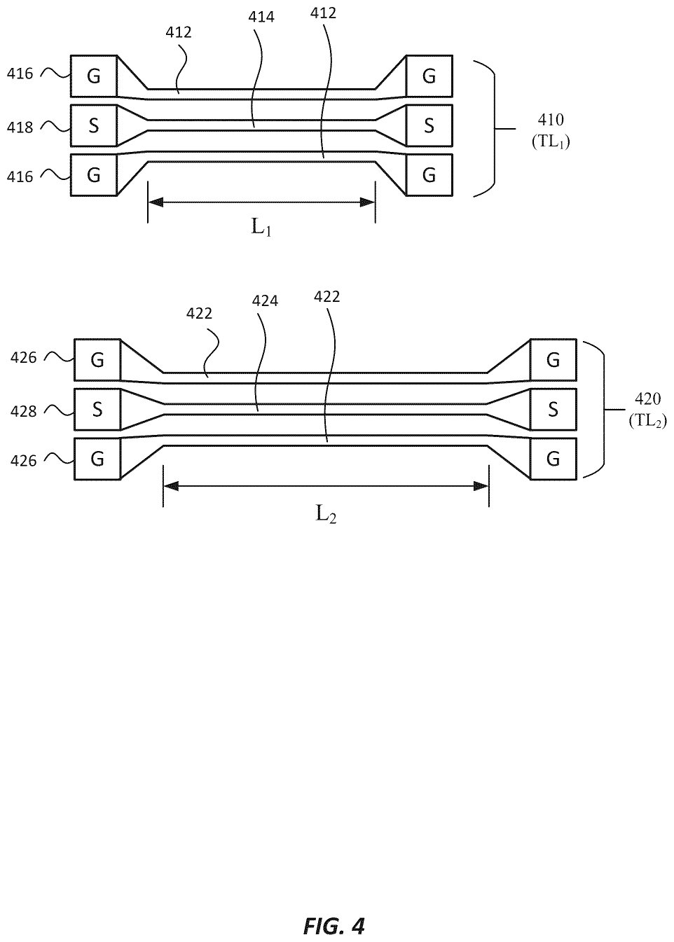

FIG. 4 illustrates another test structure that includes a first transmission line 410 (TL₁) and a second transmission line 420 (TL₂) formed on a wafer. Similar to the test structure illustrated in FIG. 3, the first transmission line 410 includes a signal line 414 terminated by a respective signal pad 418 at each end thereof. The first transmission line 410 includes two metal traces 412 for the ground. Each metal trace 412 is terminated by a respective ground pad 416 at each end thereof. The second transmission line 420 includes a signal line 424 terminated by a respective signal pad 428 at each end thereof. The second transmission line 420 includes two metal traces 422 for the ground. Each metal trace 422 is terminated by a respective ground pad 426 at each end thereof. In this embodiment, the signal lines 414 and 424, as well as the metal traces 412 and 422, have tapered portions at the ends. The first transmission line 410 has a first length L₁. The second transmission line 420 has a second length L₂. Here, the length of the transmission line refers to the length of the portion of the signal line 414 or 424 that is not tapered, or the length of the portion of the metal trace 412 or 422 that is not tapered, whichever is smaller. According to embodiments of the present disclosure, the ratio of the first length L₁ to the second length L₂ can be arbitrary.

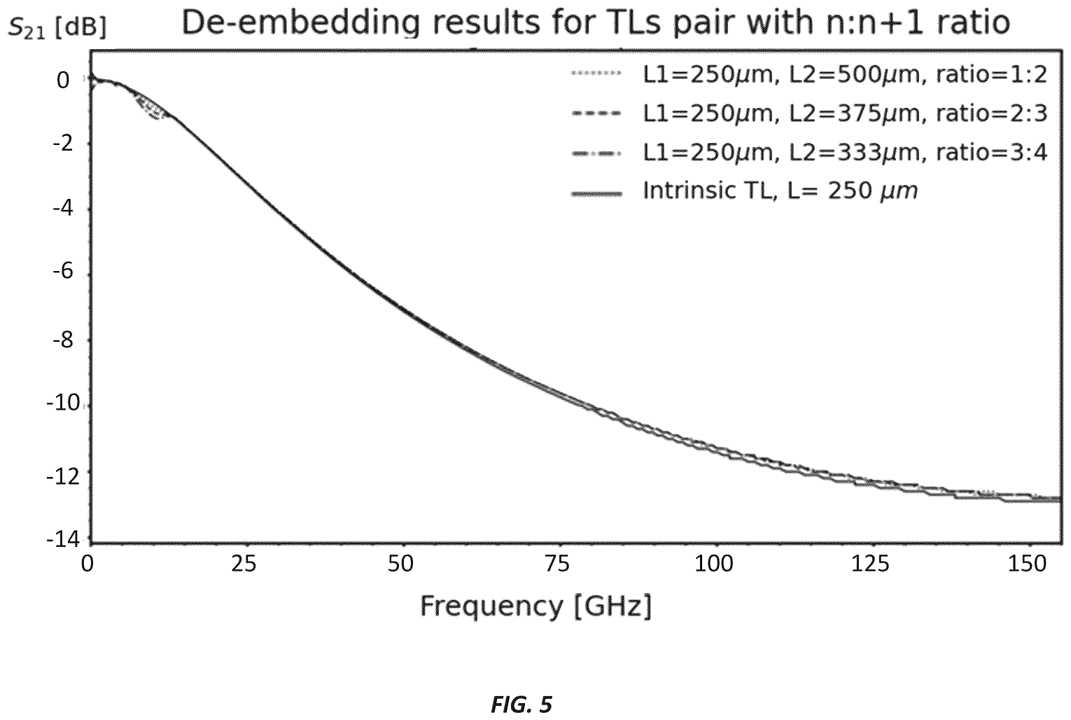

The de-embedding method described above is tested using transmission lines with length ratios of n:(n+1). In FIG. 5, de-embedding results for transmission line pairs with the following length pairs are shown: L₁=250 μm, L₂=500 μm (ratio=1:2); L₁=250 μm, L₂=375 μm (ratio=2:3); and L₁=250 μm, L₂=333 μm (ratio=3:4). The vertical axis is the intrinsic S-parameter S₂₁ of the first transmission line (L)=250 μm). (The de-embedded T-matrix is converted into de-embedded S-matrix.) The horizontal axis is the frequency. The S-parameter S₂₁ of a transmission line with a length L=250 μm without the pads, obtained by electromagnetic (EM) simulation, are shown in a solid line as a benchmark. As illustrated, the de-embedding results for all three cases agree quite well with the EM simulation results beyond 150 GHZ, demonstrating the effectiveness of the de-embedding method for high-frequency applications, including photonic applications where accuracy beyond 150 GHz is important for performance.

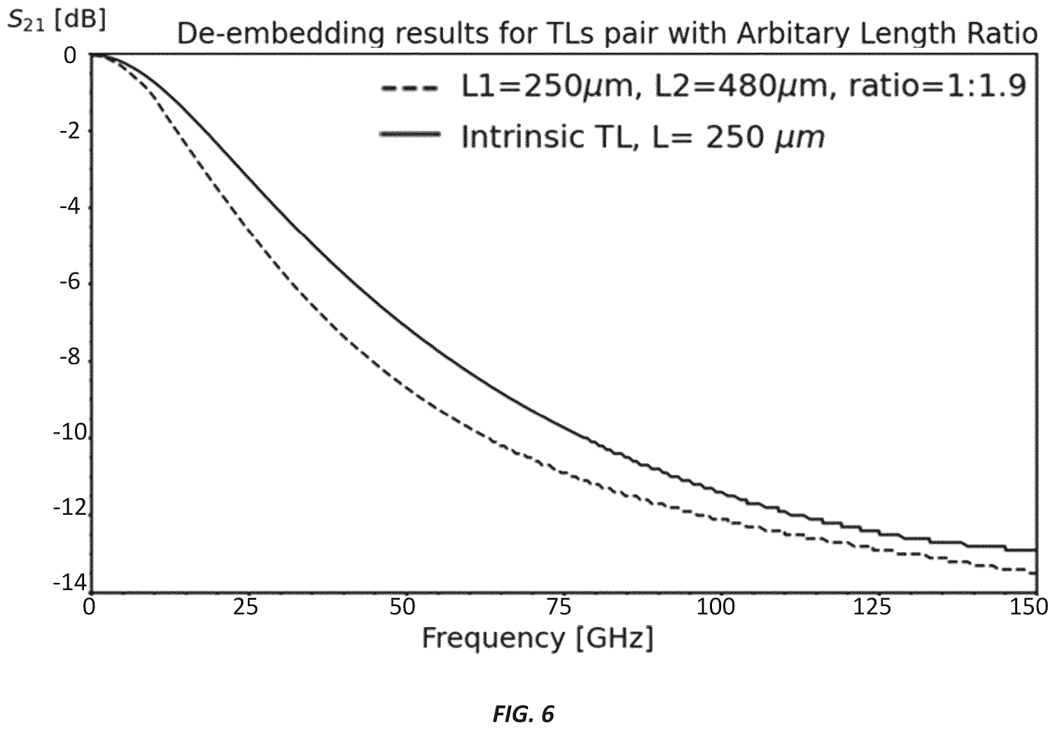

The de-embedding method described above is also evaluated using transmission lines with arbitrary length ratios. In FIG. 6, de-embedding results for a transmission line pair with L₁=250 μm, and L₂=480 μm (ratio=1:1.9) are shown as a dashed line. The vertical axis is the intrinsic S-parameter S₂₁ of the first transmission line (L₁=250 μm). The horizontal axis is the frequency. The S-parameter S₂₁ of a transmission line with a length L=250 μm without the pads, obtained by EM simulation, are shown in a solid line as a benchmark. As illustrated, the de-embedding results agree well with the EM simulation results beyond 150 GHz, demonstrating the flexibility and broad applicability of the de-embedding method.

The de-embedding method described above is not limited to two-port transmission lines (for example in the GSG configuration). It can also be applied to multi-port transmission lines. Since the T matrices are inherently for N-port networks, the algorithm described above with reference to FIG. 2 and Equations (1) through (11) can also be used for multi-port transmission lines.

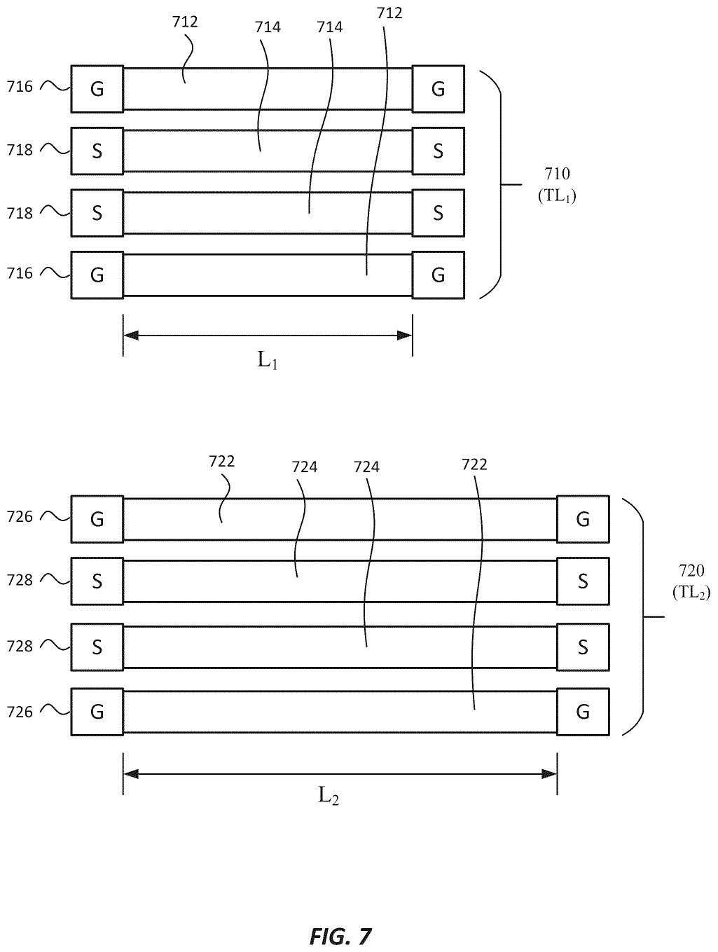

For example, FIG. 7 illustrates a test structure that includes multi-port transmission lines in a ground-signal-signal-ground (GSSG) configuration. The test structure includes a first transmission line 710 (TL₁) and a second transmission line 720 (TL₂) formed on a wafer. The first transmission line 710 includes two signal lines 714, each signal line 714 being terminated by a respective signal pad 718 at each end thereof. The first transmission line 710 includes two metal traces 712 for the ground. Each metal trace 712 is terminated by a respective ground pad 716 at each end thereof. The second transmission line 720 includes two signal lines 724, each signal line 724 being terminated by a respective signal pad 728 at each end thereof. The second transmission line 720 includes two metal traces 722 for the ground. Each metal trace 722 is terminated by a respective ground pad 726 at each end thereof. According to some embodiments, the first transmission line 710 and the second transmission line 720 are coplanar waveguides. In this embodiment, the signal lines 714 and 724, as well as the metal traces 712 and 722, are all straight, and have the same width.

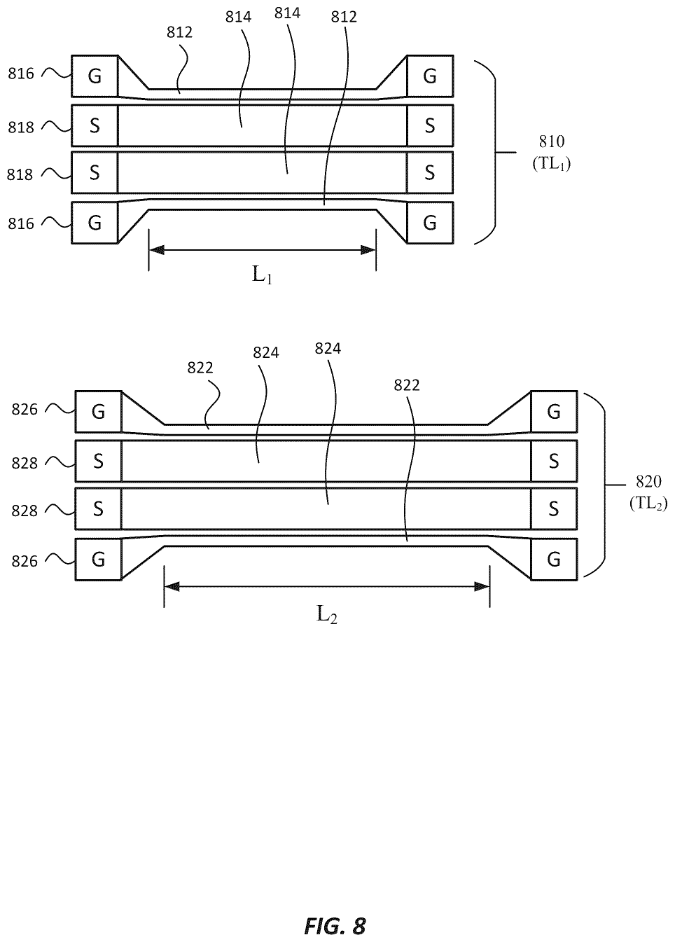

FIG. 8 illustrates another test structure that includes multi-port transmission lines in a GSSG configuration. The test structure includes a first transmission line 810 (TL₁) and a second transmission line 820 (TL₂). Similar to the test structure illustrated in FIG. 7, The first transmission line 310 includes two signal lines 814, each signal line 814 being terminated by a respective signal pad 818 at each end thereof. The first transmission line 810 includes two metal traces 812 for the ground. Each metal trace 812 is terminated by a respective ground pad 816 at each end thereof. The second transmission line 820 includes two signal line 824, each signal line 824 being terminated by a respective signal pad 828 at each end thereof. The second transmission line 820 includes two metal traces 822 for the ground. Each metal trace 822 is terminated by a respective ground pad 826 at each end thereof. In this embodiment, the signal lines 814 and 824 are straight, but the metal traces 812 and 822 have tapered portions at the ends. The first transmission line 810 has a first length L₁. The second transmission line 820 has a second length L₂. Here, the length of a transmission line refers to the length of the portion of the metal trace 812 or 822 that is not tapered. In some other embodiments, the signal lines 818 and 828 can also have tapered portions at the ends. Also, multi-port transmission lines can have configurations different from the GSSG configuration, such as GSGSG, SS, GSSSG, or other configurations.

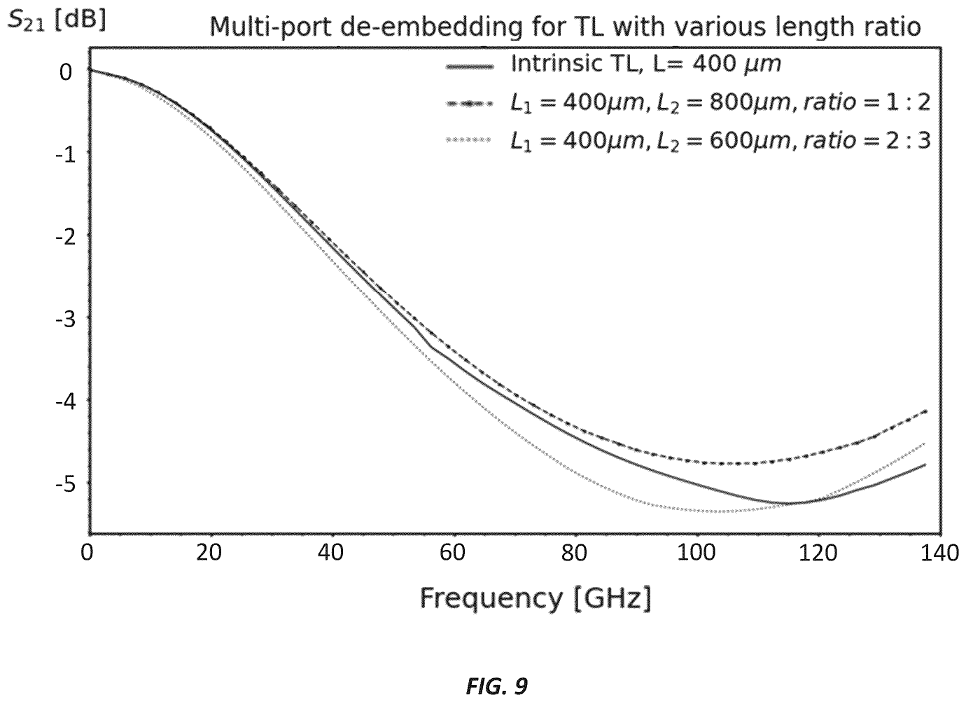

The de-embedding method described above is tested using a test structure with two-port transmission lines as illustrated in FIG. 7. In FIG. 9, de-embedding results for transmission line pairs with the following length pairs are shown: L₁=400 μm, L₂=800 μm (ratio=1:2); and L₁=400 μm, L₂=600 μm (ratio=2:3). The S-parameter S₂₁ of a transmission line with a length L=400 μm without the pads, obtained by EM simulation, are shown in a solid line as a benchmark. As illustrated, the de-embedding results for both cases agree quite well with the EM simulation results beyond 140 GHz, demonstrating the effectiveness of the method for multi-port transmission lines.

According to some embodiments, to improve the de-embedding accuracy, an empirical de-embedding coefficient c_{f} is introduced. The empirical de-embedding coefficient c_{f} is derived from 3D EM simulations, and allows for fine-tuning of the de-embedding process to account for any residual parasitic effects.

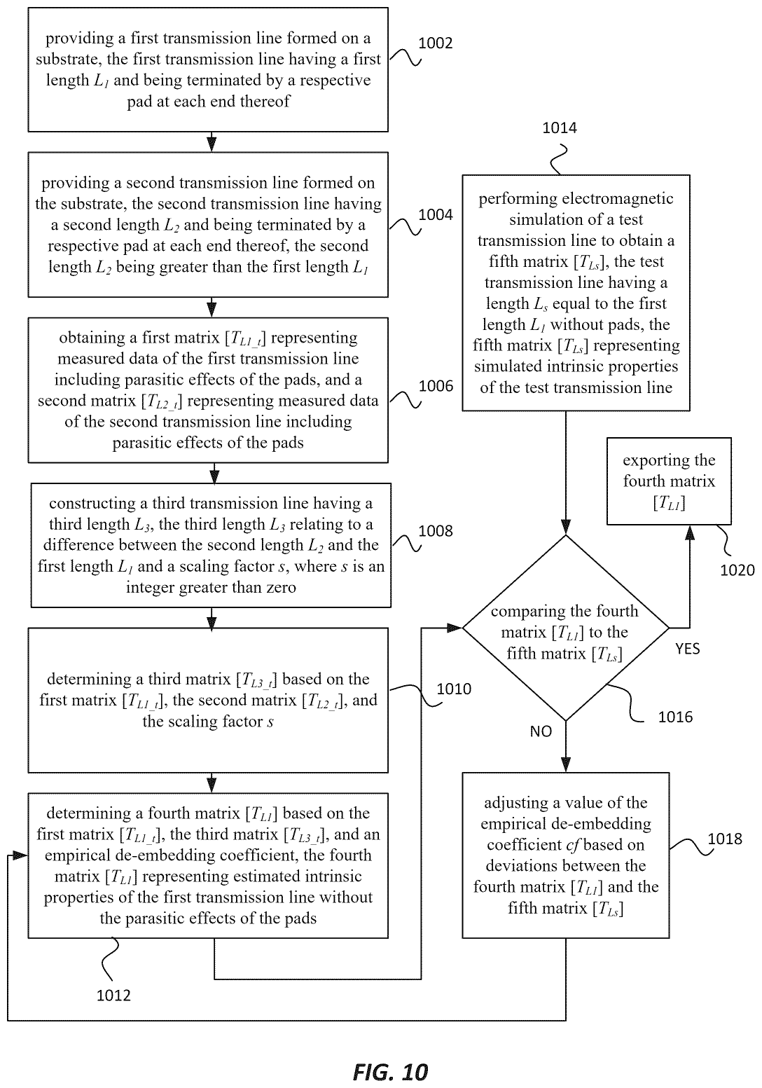

FIG. 10 shows a flowchart illustrating a method of de-embedding that uses am empirical de-embedding coefficient according to some embodiments. The method includes, at 1002, providing a first transmission line TL₁ formed on a wafer. The first transmission line TL₁ has a first length L₁ and is terminated by a respective pad at each end thereof. The method further includes, at 1004, providing a second transmission line TL₂ formed on the wafer. The second transmission line TL₂ has a second length L₂ and is terminated by a respective pad at each end thereof. The second length L₂ is greater than the first length L₁.

The method further includes, at 1006, obtaining a first matrix [T_{L1_t}] representing measured data of the first transmission line TL₁, and a second matrix [T_{L2_t}] representing measured data of the second transmission line TL₂. The subscript “_t” denotes that the measured data includes parasitic effects of the pads. In some embodiments, each of the first matrix [T_{L1_t}] and the second matrix [T_{L2_t}] is a T-matrix. If raw measured data are represented by S-matrix, the method can further include converting the S-matrix into T-matrix.

The method further includes, at 1008, constructing a third transmission line having a third length L₃. The third length L₃ relates to a difference between the second length L₂ and the first length L₁ and a scaling factor s, where s is an integer greater than zero. In some embodiments, L₃ and s are expressed as Equations (3) and (4). The method further includes, at 1010, determining a third matrix [T_{L3_t}] according to Equation (5).

The method further includes, at 1012, determining a fourth matrix [T_{L1}] based on the first matrix [T_{L1_t}], the third matrix [T_{L3_t}], and an empirical de-embedding coefficient cf. The fourth matrix [T_{L1}] represents estimated intrinsic properties of the first transmission line without the parasitic effects of the pads. The method can further include determining the matrix [T_{L2}] based on the second matrix [T_{L2_t}+], the third matrix [T_{L3_t}], and the empirical de-embedding coefficient cf. The matrix [T_{L2}] represents estimated intrinsic properties of the second transmission line TL₂ without the parasitic effects of the pads. The matrices [T_{L1}] and [T_{L2}] can be obtained as the following:

$$[ {T}_{L 1} ] = {[ {[ {T}_{L {3}_{t}} ]}^{\frac{- 1}{2}} * [ {T}_{L {1}_{t}} ] * {[ {T}_{L {3}_{t}} ]}^{\frac{- 1}{2}} ]}^{\frac{L 1}{{L}_{1} - {L}_{3}} \times c f} , and \qquad Eqn . ( 12 )$$

$$[ {T}_{L 2} ] = {[ {[ {T}_{L {3}_{t}} ]}^{\frac{- 1}{2}} * {[ {T}_{L {2}_{t}} ] [ {T}_{L {3}_{t}} ]}^{\frac{- 1}{2}} ]}^{\frac{{L}_{2}}{{L}_{2} - {L}_{3}} \times c f} , \qquad Eqn . ( 13 )$$

The value of cf may be initially set to 1, and will be adjusted subsequently, as described below.

The method further includes, at 1014, performing electromagnetic simulation of a test transmission line to obtain a fifth matrix [T_{Ls}]. The test transmission line has a length Lₛ equal to the first length L₁ and has the same geometry as the first transmission line TL₁, but without pads. The fifth matrix [T_{Ls}] represents simulated intrinsic properties of the test transmission line.

The method further includes, at 1016, comparing the fourth matrix [T_{L1}] to the fifth matrix [T_{Ls}]. In some embodiments, if the simulated intrinsic properties of the test transmission line are represented as S-matrix, the simulated S-matrix may be converted into simulated T-matrix before performing the comparison. Alternatively, the estimated intrinsic properties of the first transmission line can be converted into S-matrix before performing the comparison.

The method further includes, at 1018, upon determining that deviations between the fourth matrix [T_{L1}] and the fifth matrix [T_{Ls}] are greater than a predetermined threshold, adjusting a value of the empirical de-embedding coefficient of based on the deviations between the fourth matrix [T_{L1}] and the fifth matrix [T_{Ls}], and performing, at 1012, the determining the fourth matrix [T_{L1}] again. Steps 1012, 1016, and 1018 are repeated until the deviations between the fourth matrix [T_{L1}] and the fifth matrix [T_{Ls}] are below the predetermined threshold. The method further includes, at 1020, upon determining that the deviations between the fourth matrix [T_{L1}] and the fifth matrix [T_{Ls}] are below the predetermined threshold, outputting the fourth matrix [T_{L1}].

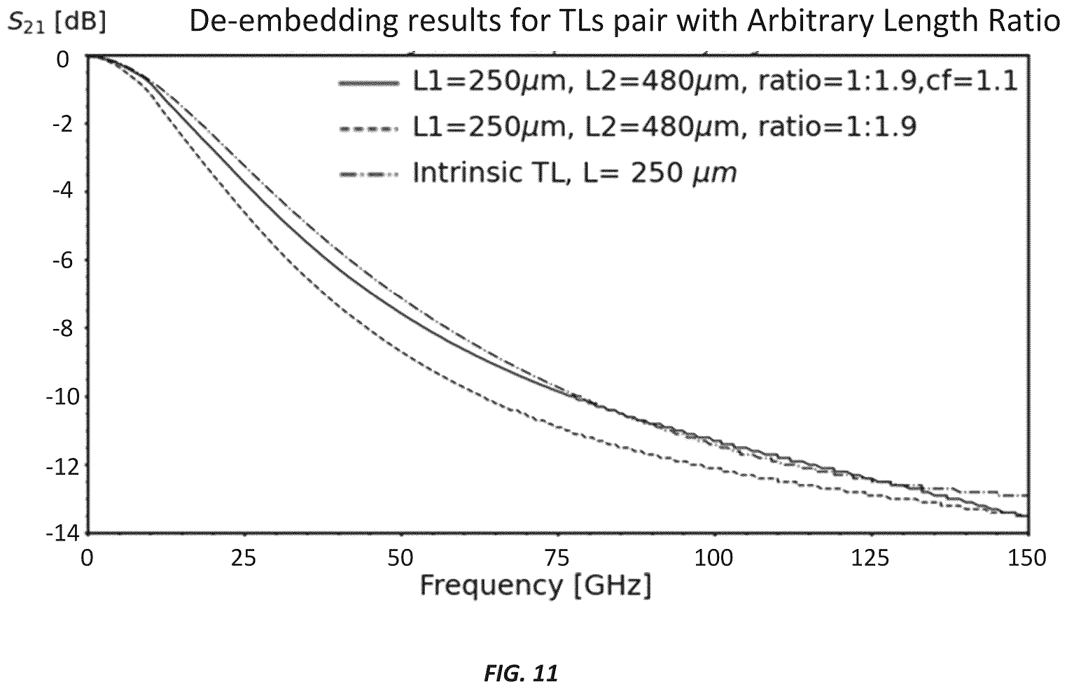

In FIG. 11, de-embedding results for a transmission line pair with L₁=250 μm and L₂=480 μm (ratio=1:1.9), obtained using an empirical de-embedding coefficient cf=1.1, are shown as a solid line. For comparison, the de-embedding results for the same transmission line pair, obtained without using the de-embedding coefficient cf, are shown as a dashed line, and the intrinsic S-parameter S₂₁ of a test transmission line with length Lₛ=250 μm, obtained by EM simulation, are shown as a dot-dash line. As illustrated, the accuracy of the de-embedding results is improved by using the empirical de-embedding coefficient cf, as compared to the de-embedding results without using the empirical de-embedding coefficient cf.

As described above, embodiments of the present disclosure provide de-embedding methods that use matrix manipulations based on cascade properties of transmission lines, to allow their applicability to any length ratio, such as ratios of n:(n+1), where n is an integer greater than one (or equal to one), as well as completely arbitrary ratios. The de-embedding methods can also be applied to transmission lines with non-uniform geometries, such as transmission lines with tapered ends, which are often used in mmWave and sub-mmWave applications. The de-embedding methods can also be applied to multi-port transmission lines with various configurations, such as transmission lines with GSSG, GSGSG, SS, or GSSSG configurations. The accuracies and effectiveness of the de-embedding methods are verified and quantified against 3D EM simulation results. Embodiments of the present disclosure also provide de-embedding methods that use an empirical de-embedding coefficient derived from 3D EM simulations. By using the empirical de-embedding coefficient, accuracies of the de-embedding methods can be further improved.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of de-embedding transmission lines, the method comprising:
providing a first transmission line formed on a wafer, the first transmission line having a first length L₁ and being terminated by a respective pad at each end thereof;
providing a second transmission line formed on the wafer, the second transmission line having a second length L₂ and being terminated by a respective pad at each end thereof, the second length L₂ being greater than the first length L₁;
obtaining a first matrix [T_{L1_t}] representing measured data of the first transmission line including parasitic effects of the pads, and a second matrix [T_{L2_t}] representing measured data of the second transmission line including parasitic effects of the pads;
constructing a third transmission line having a third length L₃, the third length L₃ relating to a difference between the second length L₂ and the first length L₁ and a scaling factor s, s being an integer greater than zero;
determining a third matrix [T_{L3_t}] based on the first matrix [T_{L1_t}], the second matrix [T_{L2_t}], and the scaling factor s; and
determining a fourth matrix [T_{L1}] based on the first matrix [T_{L1_t}] and the third matrix [T_{L3_t}], the fourth matrix [T_{L1}] representing intrinsic properties of the first transmission line without the parasitic effects of the pads.

2. The method of claim 1, further comprising determining a fifth matrix [T_{L2}] based on the second matrix [T_{L2_t}] and the third matrix [T_{L3_t}], the fifth matrix [T_{L2}] representing intrinsic properties of the second transmission line without the parasitic effects of the two pads.

3. The method of claim 1, wherein the first length is equal to a base length multiplied by n, the second length is equal to the base length multiplied by n+1, where n is an integer greater than or equal to 1.

4. The method of claim 3, wherein the third length is equal to zero, and the scaling factor s is equal to n.

5. The method of claim 4, wherein the fourth matrix [T_{L1}] is obtained as follows:
$$[ {T}_{L 1} ] = {[ {T}_{L {3}_{t}} ]}^{\frac{- 1}{2}} \times [ {T}_{L {1}_{t}} ] \times {[ {T}_{L {3}_{t}} ]}^{\frac{- 1}{2}} .$$

6. The method of claim 1, wherein the scaling factor s is an integer relating to a ratio of the first length and the difference between the first length and the second length.

7. The method of claim 1, wherein L₃=s(L₁−L₂)+L₁, and the scaling factor s is a greatest integer less than or equal to
$$\frac{{L}_{1}}{{L}_{2} - {L}_{1}} .$$

8. The method of claim 7, wherein the fourth matrix [T_{L1}] is obtained as follows:
$$[ {T}_{L 1} ] = {[ {[ {T}_{L {3}_{t}} ]}^{\frac{- 1}{2}} * [ {T}_{L {1}_{t}} ] * {[ {T}_{L {3}_{t}} ]}^{\frac{- 1}{2}} ]}^{\frac{L 1}{{L}_{1} - {L}_{3}}} .$$

9. The method of claim 1, wherein the first transmission line and the second transmission line are coplanar waveguides formed on the wafer.

10. The method of claim 1, wherein the first transmission line and the second transmission line operate at millimeter-wave frequencies or sub-terahertz frequencies.

11. The method of claim 1, wherein each of the first transmission line and the second transmission line includes tapered portions at ends thereof, the first matrix [T_{L1_t}] represents the measured data of the first transmission line including the parasitic effects of the pads and parasitic effects of the tapered portions of the first transmission line, the second matrix [T_{L2_t}] represents the measured data of the second transmission line including the parasitic effects of the pads and parasitic effects of the tapered portions of the second transmission line, and the fourth matrix [T_{L1}] represents intrinsic properties of the first transmission line without the parasitic effects of the pads and the parasitic effects of the tapered portions of the first transmission line.

12. The method of claim 1, wherein the first transmission line and the second transmission line are multi-port transmission lines.

13. A method of de-embedding transmission lines, the method comprising:
providing a first transmission line formed on a wafer, the first transmission line having a first length L₁ and being terminated by a respective pad at each end thereof;
providing a second transmission line formed on the wafer, the second transmission line having a second length L₂ and being terminated by a respective pad at each end thereof, the second length L₂ being greater than the first length L₁;
obtaining a first matrix [T_{L1_t}] representing measured data of the first transmission line including parasitic effects of the pads, and a second matrix [T_{L2_t}] representing measured data of the second transmission line including parasitic effects of the pads;
constructing a third transmission line having a third length L₃, the third length L₃ relating to a difference between the second length L₂ and the first length L₁ and a scaling factor s, s being an integer greater than zero;
determining a third matrix [T_{L3_t}] based on the first matrix [T_{L1_t}], the second matrix [T_{L2_t}], and the scaling factor s;
determining a fourth matrix [T_{L1}] based on the first matrix [T_{L1_t}], the third matrix [T_{L3_t}], and an empirical de-embedding coefficient cf, the fourth matrix [T_{L1}] representing estimated intrinsic properties of the first transmission line without the parasitic effects of the pads;
performing electromagnetic simulation of a test transmission line to obtain a fifth matrix [T_{Ls}], the test transmission line having a length Lₛ equal to the first length L₁ without pads, the fifth matrix [T_{Ls}] representing simulated intrinsic properties of the test transmission line;
comparing the fourth matrix [T_{L1}] to the fifth matrix [T_{Ls}];
upon determining that deviations between the fourth matrix [T_{L1}] to the fifth matrix [T_{Ls}] are greater than a predetermined threshold, adjusting a value of the empirical de-embedding coefficient cf based on the deviations between the fourth matrix [T_{L1}] and the fifth matrix [T_{Ls}]; and
performing the determining the fourth matrix [T_{L1}] again until the deviations between the fourth matrix [T_{L1}] and the fifth matrix [T_{Ls}] are below a predetermined threshold.

14. The method of claim 13, wherein L₃=s(L₁−L₂)+L₁, and the scaling factor s is a greatest integer less than or equal to
$$\frac{{L}_{1}}{{L}_{2} - {L}_{1}} .$$

15. The method of claim 14, wherein the fourth matrix [T_{L1}] is obtained as follows:
$$[ {T}_{L 1} ] = {[ {[ {T}_{L {3}_{t}} ]}^{\frac{- 1}{2}} * [ {T}_{L {1}_{t}} ] * {[ {T}_{L {3}_{t}} ]}^{\frac{- 1}{2}} ]}^{\frac{L 1}{{L}_{1} - {L}_{3}} \times c f} .$$

16. The method of claim 15, wherein the empirical de-embedding coefficient c_{f} has an initial value of 1.

17. A non-transitory computer-readable storage medium storing instructions that, when executed by one or more processors, cause a computing device to perform a method of de-embedding transmission lines, the method comprising:
obtaining a first matrix [T_{L1_t}] representing measured data of a first transmission line formed on a wafer, the first transmission line having a first length L₁ and being terminated by a respective pad at each end thereof, the measured data of the first transmission line including parasitic effects of the pads,
obtaining a second matrix [T_{L2_t}] representing measured data of a second transmission line formed on the wafer, the second transmission line having a second length L₂ and being terminated by a respective pad at each end thereof, the measured data of the second transmission line including parasitic effects of the pads, the second length L₂ being greater than the first length L₁;
constructing a third transmission line having a third length L₃, the third length La relating to a difference between the second length L₂ and the first length L₁ and a scaling factor s, s being an integer greater than zero;
determining a third matrix [T_{L3_t}] based on the first matrix [T_{L1_t}], the second matrix [T_{L2_t}], and the scaling factor s; and
determining a fourth matrix [T_{L1}] based on the first matrix [T_{L1_t}] and the third matrix [T_{L3_t}], the fourth matrix [T_{L1}] representing intrinsic properties of the first transmission line without the parasitic effects of the pads.

18. The non-transitory computer-readable storage medium of claim 17, wherein L₃=s(L₁−L₂)+L₁, and the scaling factor s is a greatest integer less than or equal to
$$\frac{{L}_{1}}{{L}_{2} - {L}_{1}} .$$

19. The non-transitory computer-readable storage medium of claim 18, wherein the fourth matrix [T_{L1}] is obtained as follows:
$$[ {T}_{L 1} ] = {[ {[ {T}_{L {3}_{t}} ]}^{\frac{- 1}{2}} * [ {T}_{L {1}_{t}} ] * {[ {T}_{L {3}_{t}} ]}^{\frac{- 1}{2}} ]}^{\frac{L 1}{{L}_{1} - {L}_{3}}} .$$

20. The non-transitory computer-readable storage medium of claim 19, wherein L₃=0, and the fourth matrix [T_{L1}] is obtained as follows:
$$[ {T}_{L 1} ] = {[ {T}_{L {3}_{t}} ]}^{\frac{- 1}{2}} \times [ {T}_{L {1}_{t}} ] \times {[ {T}_{L {3}_{t}} ]}^{\frac{- 1}{2}} .$$
